(19) United States
(12) Patent Application Publication
(10) Pub. No.: US 2015/0103392 A1
(43) Pub. Date: Apr. 16, 2015

(54) DISPLAY WITH RETROREFLECTIVE ELEMENTS

(71) Applicant: SYNOPSYS, INC., MOUNTAIN VIEW, CA (US)

(72) Inventor: Michael L. Rieger, Skamania, WA (US)

(73) Assignee: SYNOPSYS, INC., MOUNTAIN VIEW, CA (US)

(21) Appl. No.: 14/106,235

(22) Filed: Dec. 13, 2013

Related U.S. Application Data
(60) Provisional application No. 61/890,079, filed on Oct. 11, 2013.

(51) Int. Cl. G02B 26/00; G02F 1/167

(52) U.S. Cl. CPC G02B 26/005; G02F 1/167; G02B 26/007
USPC 359/296; 359/238; 359/290

(57) ABSTRACT

In one embodiment, an apparatus includes a retroreflector pixel that includes multiple retroreflector sub-pixels. Each retroreflector sub-pixel includes a reflective surface configured to reflect incident light. Each retroreflector sub-pixel also includes a filter element configured to filter out from the incident light an electrically-controllable amount of light over a particular wavelength range. The filter element may utilize an electrophoretic technique based on charged particles, an electrowetting technique based on a dyed fluid, or an evanescent-wave coupling technique. The apparatus may include a controller communicably coupled to the retroreflector pixel and operable to control the filter element of each retroreflector sub-pixel.

### PRIORITY

This application claims the benefit, under 35 U.S.C. §119(e), of U.S. Provisional Patent Application No. 61/890,079, filed 11 Oct. 2013, which is incorporated herein by reference.

### TECHNICAL FIELD

This disclosure generally relates to displays that include retroreflective elements.

### BACKGROUND

Color display technologies include liquid-crystal displays (LCD), which include a backlight, light-emitting diode (LED) displays, and organic LED (OLED) displays. These display technologies can consume non-negligible amounts of power and can have poor visibility in bright light (e.g., sunlight). e-Readers based on electrophoretic technology consume significantly lower power, may have good visibility in bright light, but are limited to monochrome.

An electronic design automation (EDA) system is a computer software system used for designing integrated circuit (IC) devices. The EDA system typically receives one or more high level behavioral descriptions of an IC device (e.g., in HDL languages like VHDL, Verilog, etc.) and translates (“synthesizes”) this high-level design language description into netlists of various levels of abstraction. A netlist describes the IC design and is composed of nodes (functional elements) and edges, e.g., connections between nodes. At a higher level of abstraction, a generic netlist is typically produced based on technology-independent primitives.

The generic netlist can be translated into a lower level technology-specific netlist based on a technology-specific (characterized) cell library that has gate-specific models for each cell (i.e., a functional element, such as an AND gate, an inverter, or a multiplexer). The models define performance parameters for the cells; e.g., parameters related to the operational behavior of the cells, such as power consumption, delay, and noise. The netlist and cell library are typically stored in computer-readable media within the EDA system and are processed and verified using many well-known techniques.

FIG. 1 illustrates a simplified representation of an example digital ASIC design flow. At a high level, the process starts with the product idea (step 10) and is realized in an EDA software design process (step 11). When the design is finalized, it can be taped-out (event 40). After tape out, the fabrication process (step 50) and packaging and assembly processes (step 60) occur resulting, ultimately, in finished chips (result 70).

The EDA software design process (step 11) is actually composed of a number of steps 12-30, shown in linear fashion for simplicity. In an actual ASIC design process, the particular design might have to go back through steps until certain tests are passed. Similarly, in any actual design process, these steps may occur in different orders and combinations. This description is therefore provided by way of context and general explanation rather than as a specific, or recommended, design flow for a particular ASIC.

A brief description of the component steps of the EDA software design process (step 11) will now be provided. During system design (step 12), the designers describe the functionality that they want to implement and can perform what-if planning to refine functionality, check costs, etc. Hardware-software architecture partitioning can occur at this stage. Example EDA software products from Synopsys, Inc. that can be used at this step include Model Architect, Saber, System Studio, and DesignWare® products.

During logic design and functional verification (step 14), the VHDL or Verilog code for modules in the system is written and the design is checked for functional accuracy. More specifically, the design is checked to ensure that it produces the correct outputs. Example EDA software products from Synopsys, Inc. that can be used at this step include VCS, VERA, DesignWare®, Magellan, Formality, ESP and LEDA products.

During synthesis and design for test (step 16), the VHDL/Verilog is translated to a netlist. The netlist can be optimized for the target technology. Additionally, the design and implementation of tests to permit checking of the finished chip occurs. Example EDA software products from Synopsys, Inc. that can be used at this step include Design Compiler®, Physical Compiler, Test Compiler, Power Compiler, FPGA Compiler, Tetramax, and DesignWare® products.

During design planning (step 18), an overall floorplan for the chip is constructed and analyzed for timing and top-level routing. Example EDA software products from Synopsys, Inc. that can be used at this step include Jupiter and Floorplan Compiler products.

During netlist verification (step 20), the netlist is checked for compliance with timing constraints and for correspondence with the VHDL/Verilog source code. Example EDA software products from Synopsys, Inc. that can be used at this step include VCS, VERA, Formality and PrimeTime products.

During physical implementation (step 22), placement (positioning of circuit elements) and routing (connection of the same) is performed. Example EDA software products from Synopsys, Inc. that can be used at this step include the Astro product.

During analysis and extraction (step 24), the circuit function is verified at a transistor level, this in turn permits what-if refinement. Example EDA software products from Synopsys, Inc. that can be used at this step include Star RC/XT, Raphael, and Aurora products.

During physical verification (step 26), various checking functions are performed to ensure correctness for: manufacturing, electrical issues, lithographic issues, and circuitry. Example EDA software products from Synopsys, Inc. that can be used at this step include the Hercules product.

During resolution enhancement (step 28), geometric manipulations of the layout are performed to improve manufacturability of the design. Example EDA software products from Synopsys, Inc. that can be used at this step include the iN-Phase, Proteus, and AFGen products.

Finally, during mask data preparation (step 30), the “tape-out” data for production of masks for lithographic use to produce finished chips is performed. Example EDA software products from Synopsys, Inc. that can be used at this step include the CATS® family of products.

### SUMMARY OF PARTICULAR EMBODIMENTS

In particular embodiments, a retroreflector pixel may be configured to operate as a subtractive-color pixel element. A retroreflector pixel may include multiple retroreflector sub-pixels, where each sub-pixel includes a reflective surface and a filter element. The reflective surface of each sub-pixel may be configured to reflect substantially all (e.g., greater than 75% of) incident light over a visible wavelength range. The filter element may be configured to filter out from an incident light beam an electrically-controllable amount of light over a particular wavelength range. As an example and not by way of limitation, a retroreflector pixel may include three sub-pixels, and each of the three sub-pixels may have a reflective surface that reflects greater than 75% of incident light over a visible wavelength range that includes red, green, and blue wavelength ranges. Additionally, the filter element of each of the three sub-pixels may be configured to filter out from the incident light source an electrically-controllable amount of light over a red, green, or blue wavelength range, respectively. In particular embodiments, a display screen may include an array of multiple retroreflector pixels configured to display text, images, or videos in black-and-white, grayscale, or color.

In particular embodiments, a retroreflector pixel may be configured to be controlled by a computing device, such as for example a display controller. An EDA system may be configured to provide a cell library for a circuit design of a display controller. A controller cell provided by the EDA system may be operable to control one or more retroreflector pixels. As an example and not by way of limitation, the controller cell provided by the EDA system may be operable to apply a voltage to an electrode of a retroreflector sub-pixel filter element and thereby configure the filter element to filter out from an incident light source an amount of light over a particular wavelength range.

### BRIEF DESCRIPTION OF THE DRAWINGS

FIG. 1 illustrates a simplified representation of an example digital ASIC design flow.

FIG. 2 illustrates a perspective view of an example retroreflector pixel.

FIG. 3 illustrates a top view of an example retroreflector pixel.

FIGS. 4A-4D illustrate example color configurations of example retroreflector pixels.

FIG. 5 illustrates an example portion of an example display that includes example retroreflector pixels arranged in an array.

FIG. 6 illustrates a side view of an example array of retroreflector pixels.

FIGS. 7A-7C illustrate an example retroreflector pixel where a dye may be used to modulate the color reflected from an example sub-pixel.

FIGS. 8A-8C illustrate an example retroreflector pixel where an electrophoretic technique may be used to modulate the color reflected from an example sub-pixel.

FIGS. 9A-9C illustrate an example retroreflector pixel where an evanescent-wave coupling technique may be used to modulate the color reflected from an example sub-pixel.

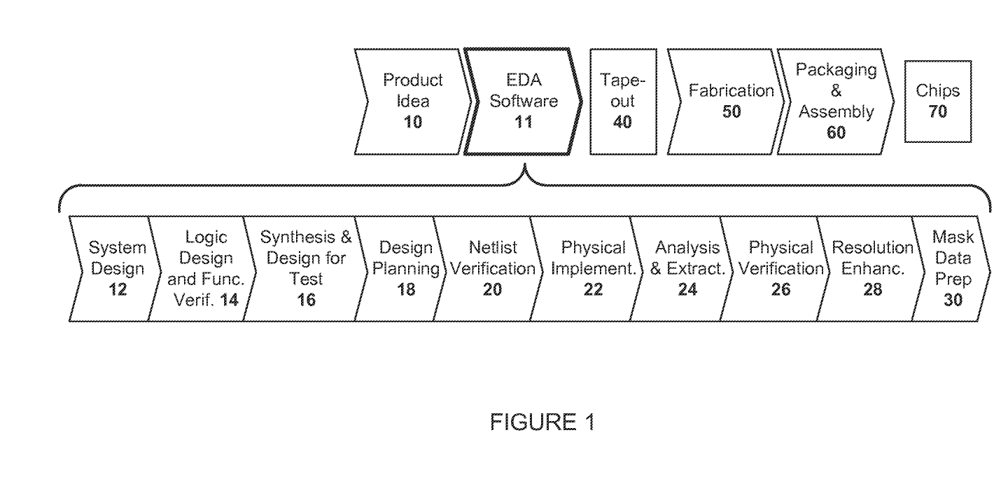

### DESCRIPTION OF EXAMPLE EMBODIMENTS

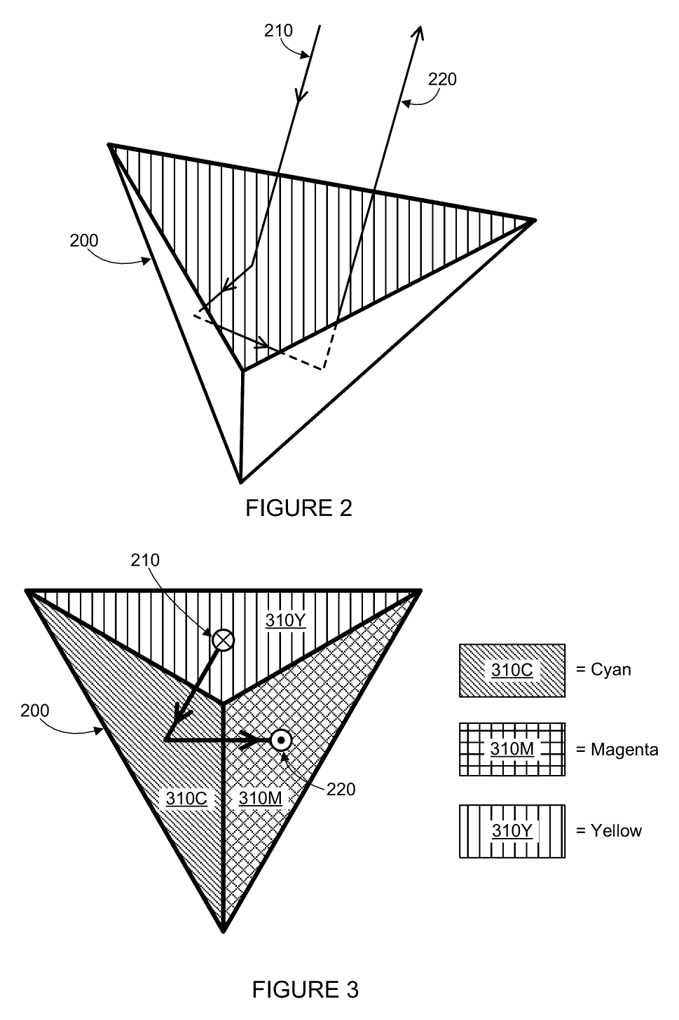

FIG. 2 illustrates a perspective view of an example retroreflector pixel 200. In particular embodiments, retroreflector pixel 200 may be referred to as a retroreflector, a retroreflective element, a retroreflective pixel element, a retroreflector prism, a corner-reflector pixel, an optical-corner reflector, or a cube-corner reflector. In the example of FIG. 2, retroreflector pixel 200 includes three faces, and the three faces are arranged substantially orthogonal to each other so that each face forms an angle of approximately 90 degrees with the other faces. In FIG. 2, each face of retroreflector pixel 200 has a triangular shape. In particular embodiments, a face of retroreflector pixel 200 may be referred to as a facet, surface, retroreflector sub-pixel, or sub-pixel. In particular embodiments, retroreflector pixel 200 may include 2, 3, 4, or any suitable number of sub-pixels.

In particular embodiments, retroreflector pixel 200 may have a shape of a truncated corner of a cube. In particular embodiments, a retroreflector may include a refracting optical element (e.g., a spherical element or a spherical lens) and a reflective surface (e.g., a flat or spherical mirror). Although this disclosure describes and illustrates particular retroreflector pixels having particular shapes and particular numbers of sub-pixels, this disclosure contemplates any suitable retroreflector pixels having any suitable shapes and any suitable numbers of sub-pixels. Although this disclosure describes and illustrates particular retroreflector pixels having sub-pixels with particular shapes and in particular arrangements, this disclosure contemplates any suitable retroreflector pixels having sub-pixels with any suitable shapes and in any suitable arrangements.

In particular embodiments, sub-pixels of retroreflector pixel 200 that are substantially orthogonal to each other may refer to surfaces of sub-pixels that form a 90-degree angle with a tolerance of ±10 degrees, ±5 degrees, ±1 degree, or any suitable angular tolerance. As an example and not by way of limitation, two sub-pixel surfaces that form a 90-degree angle with a tolerance of ±5 degrees may form an 85-degree angle, a 95-degree angle, or any suitable angle between 85 and 95 degrees. In particular embodiments, a non-orthogonal angle between two or more sub-pixels of retroreflector pixel 200 may result from an intentional angular variation or offset that is part of a retroreflector pixel design. In particular embodiments, a variation in angles between sub-pixels of retroreflector pixel 200 may be the result of opto-mechanical tolerances or assembly variations that may occur during assembly or manufacture of retroreflector pixel 200. Although this disclosure describes and illustrates particular sub-pixels of retroreflector pixels that form particular angles and have particular shapes, this disclosure contemplates any suitable sub-pixels that form any suitable angles and have any suitable shapes.

In the example of FIG. 2, retroreflector pixel 200 has sub-pixels that are substantially planar (or, flat). In particular embodiments, each sub-pixel of retroreflector pixel 200 may have a surface that is substantially planar, convex, concave, or varying (e.g., a surface with a sinusoidal surface variation), or may have any suitable surface shape or suitable combination of such surface shapes. In particular embodiments, a substantially-planar surface may refer to a flat surface with a surface-height variation of less than 10%, 5%, 1%, or any suitable percentage. As an example and not by way of limitation, a surface with a characteristic dimension (e.g., length or width) of 1 mm and a surface-height variation of 1% or less may have a surface height that deviates by 10 μm (=0.01×1-mm) or less from an average or nominal surface height.

In particular embodiments, each sub-pixel of retroreflector pixel 200 may include an optically-reflective surface that reflects incident light 210. In particular embodiments, a reflective surface of a sub-pixel of retroreflector pixel 200 may have a substantially planar surface shape or may have a convex or concave surface shape. In particular embodiments, light ray 210 that is incident on retroreflector pixel 200 may reflect off of the reflective surfaces of each retroreflector sub-pixel in sequence. This disclosure contemplates any suitable sequence of reflections from the reflective surfaces of retroreflector pixel 200. In particular embodiments, light that is incident on or reflected from retroreflector pixel 200 may be referred to as a light ray, an input or output light ray, an input or output beam, a light beam, an optical beam, a light source, or an illumination source. FIG. 2 illustrates an example input optical beam 210 that reflects off of each of the three orthogonal faces of retroreflector pixel 200 and then emerges from retroreflector pixel 200 as output beam 220. In particular embodiments, output beam 220 may be referred to as a reflected beam or a retroreflected beam that is reflected or retroreflected from retroreflector pixel 200. In FIG. 2, light rays 210 and 220 may represent the same light ray with light ray 210 representing an input or incident beam and light ray 220 representing the incident beam as it emerges from or exits from retroreflector pixel 200. In particular embodiments, output beam 220 may have a lower optical power than input beam 210. In particular embodiments, output beam 220 may include fewer colors or wavelengths of light than input beam 210.

In particular embodiments, output beam 220 may be retroreflected back substantially parallel to input beam 210 but in a direction opposite to input beam 210. In FIG. 2, light ray 210 is incident on retroreflector pixel 200 at some angle relative to a reference plane of retroreflector 200. After reflecting off the three faces of retroreflector 200, incident light ray 210 may be retroreflected as output ray 220 having substantially the same angle relative to the reference plane as incident light ray 210 but traveling in a direction opposite to incident light ray 210. Output light ray 220 may exit retroreflector pixel 200 in a direction substantially parallel to input light ray 210 with a lateral displacement or offset relative to input ray 210. Although this disclosure describes and illustrates particular light rays incident on a retroreflector pixel from particular directions, this disclosure contemplates any suitable number of light rays incident on a retroreflector pixel from any suitable directions. Although this disclosure describes and illustrates particular light rays incident on particular faces of retroreflector pixel 200 in a particular order or sequence, this disclosure contemplates any suitable light rays incident on any suitable faces of retroreflector pixel 200 in any suitable order or sequence.

In particular embodiments, an optically-reflective surface that is part of a sub-pixel of retroreflector pixel 200 may include a reflective metal surface, a surface with a reflective dielectric coating, or a surface configured to reflect light by total internal reflection. As an example and not by way of limitation, a reflective metal surface of a sub-pixel of retroreflector pixel 200 may include a substrate (e.g., a piece of glass, plastic, polymer, or metal) with a reflective coating of aluminum, silver, or gold deposited onto a surface of the substrate. In particular embodiments, a reflective metal surface may additionally include a dielectric coating over the reflective metal coating where the dielectric coating may protect the metal coating from damage, scratches, degradation, or tarnishing. In particular embodiments, a reflective metal surface may also include a dielectric coating over the reflective metal coating where the dielectric coating may enhance or increase the reflectivity of the metal coating over a particular wavelength range. In particular embodiments, a dielectric coating on a reflective metal coating may provide both protection and enhanced reflectivity to the metal coating. As another example and not by way of limitation, a surface with a reflective dielectric coating may include a substrate (e.g., a piece of glass, plastic, polymer, or metal) with a multi-layer dielectric coating configured to provide optical reflectivity over a particular wavelength range, such as for example a visible wavelength range. In particular embodiments, a dielectric coating may refer to one or more thin-film layers of one or more dielectric materials deposited on an optical surface.

As another example and not by way of limitation, a surface configured to reflect light by total internal reflection may include a substantially transparent optical material (e.g., glass, plastic, or polymer) through which optical beam 210 may propagate and an optical interface where optical beam 210 may be reflected by total internal reflection. In particular embodiments, retroreflector pixel 200 or a sub-pixel of retroreflector pixel 200 may include a piece of glass that incident optical beam 210 propagates through, and the back surface of the piece of glass may include a glass-air interface. The critical angle of a glass-air interface may be defined as θ_{c}=arcsin(nₐᵢᵣ/n_{glass})′ where nₐᵢᵣ is the refractive index of air and n_{glass} is the refractive index of the glass material. As an example and not by way of limitation, for nₐᵢᵣ=1.0 and n_{glass}=1.5, the critical angle is approximately 41.8 degrees, and any optical beam propagating within the glass material and incident on the glass-air interface at an angle of incidence (relative to a surface normal) of 41.8 degrees or greater may be reflected from the glass-air interface by total internal reflection. Although this disclosure describes and illustrates particular retroreflector pixels with particular optically-reflective surfaces, this disclosure contemplates any suitable retroreflector pixels having any suitable optically-reflective surfaces.

In particular embodiments, a visible wavelength range may refer to optical wavelengths from approximately 390-450 nm at the blue-violet end of the visible spectrum to approximately 700-750 nm at the red end of the visible spectrum. As examples and not by way of limitation, visible light may include light in a wavelength range of approximately 400 nm to 700 nm, approximately 390 nm to 750 nm, approximately 450 nm to 700 nm, or any suitable visible wavelength range. Although this disclosure describes and illustrates particular visible wavelength ranges and particular wavelength ranges within a visible wavelength range, this disclosure contemplates any suitable visible wavelength ranges and any suitable wavelength ranges within a visible wavelength range.

In particular embodiments, a reflective surface of a sub-pixel of retroreflector pixel 200 may be configured to reflect incident light over one or more particular wavelength ranges and may be configured to have a particular reflectivity over one or more particular wavelength ranges. In particular embodiments, a reflective surface of a sub-pixel of retroreflector pixel 200 may be configured to reflect incident light over a range of angles of incidence, where an angle of incidence may be defined as an angle of input beam 210 relative to a normal of the reflective surface. As an example and not by way of limitation, a sub-pixel reflective surface may have a reflectivity of greater than 60%, 70%, 80%, or any suitable reflectivity. As another example and not by way of limitation, a sub-pixel reflective surface may have a reflectivity of greater than 65%, 75%, or 85% over a visible wavelength range. As another example and not by way of limitation, a sub-pixel reflective surface may have a reflectivity of greater than 60%, 70%, or 80% over a visible wavelength range and over angles of incidence from 0 degrees (e.g., normal to the reflective surface) to any suitable angle of incidence, such as for example 45 degrees, 60 degrees, or 75 degrees. Although this disclosure describes and illustrates sub-pixel reflective surfaces having particular optical reflectivity over particular wavelength ranges and over particular angles of incidence, this disclosure contemplates sub-pixel reflective surfaces having any suitable optical reflectivity over any suitable wavelength ranges and over any suitable angles of incidence.

In particular embodiments, retroreflector pixel 200 may include sub-pixels arranged around a substantially-hollow (e.g., air-filled) interior volume. In particular embodiments, retroreflector pixel 200 may include sub-pixels arranged around a solid interior volume, where the interior volume may be made from glass, plastic, or any suitable optical material. In particular embodiments, each sub-pixel or part of each sub-pixel of retroreflector pixel 200 arranged around a solid interior volume may be attached to or in optical contact with a surface of the solid interior volume. In particular embodiments, each sub-pixel or part of each sub-pixel arranged around a solid interior volume may be offset from a surface of the solid interior volume by a gap with a fixed offset distance or by a gap with a variable or electrically-controllable offset distance. In particular embodiments, input beam 210 or output beam 220 may propagate through a solid interior volume of retroreflector pixel. In particular embodiments, retroreflector pixel 200 or sub-pixels may include one or more optical elements (e.g., lenses, diffusers, filters, plates, windows, or any suitable optical element or combination of suitable optical elements) that input beam 210 or output beam 220 may propagate through.

In particular embodiments, retroreflector pixel 200 or sub-pixels may include optical elements made of substantially-transparent optical materials (e.g., glass, plastic, or polymer). In particular embodiments, optical materials that are substantially transparent may refer to materials with low amounts of optical scatter or optical absorption over a particular wavelength range, such as for example over a visible wavelength range (e.g., 400-700 nm). As an example and not by way of limitation, materials with low amounts of optical scatter or absorption may refer to materials with optical attenuation coefficients or optical absorption coefficients of less than 0.1 cm⁻¹, 0.2 cm⁻¹, 0.3 cm⁻¹ over a visible wavelength range. As another example and not by way of limitation, materials with low amounts of optical scatter or absorption may refer to materials with an optical transmission of greater than 70%, 80%, or 90% per 10-mm of material thickness over a visible wavelength range. Although this disclosure describes and illustrates particular optical materials with particular optical transmission or absorption properties over particular wavelength ranges, this disclosure contemplates any suitable optical materials with any suitable optical transmission or absorption properties over any suitable wavelength ranges.

In particular embodiments, optical elements of retroreflector pixel 200 or sub-pixels may include one or more surfaces with an anti-reflection (AR) optical coating. As an example and not by way of limitation, retroreflector pixel 200 may include a solid interior volume or a cover, and one or more surfaces of the solid interior volume or the cover may have an AR coating. In particular embodiments, an AR coating may refer to an anti-reflective dielectric coating deposited on an optical surface, where the dielectric coating may include one or more thin-film layers of one or more dielectric materials, such as for example magnesium fluoride, silicon dioxide, tantalum pentoxide, zinc sulfide, or titanium dioxide. In particular embodiments, an AR coating may reduce optical reflectivity or loss at an interface due to specular reflection. As an example and not by way of limitation, a piece of glass without an AR coating may have a reflectivity of approximately 4% per surface, and an AR coating may reduce the reflectivity to less than 1%, 0.5%, or any suitable value. As another example and not by way of limitation, an AR coating applied to an optical material, such as for example glass or plastic, may provide a reflectivity of less than 1% over a particular wavelength range, such as for example over a visible wavelength range. As another example and not by way of limitation, an AR coating applied to an optical material may provide a reflectivity of less than 1% over a particular wavelength range and over angles of incidence from 0 degrees to any suitable maximum angle of incidence, such as for example a 45-degree, 60-degree, or 75-degree angle of incidence. Although this disclosure describes and illustrates particular optical elements having particular AR coatings with particular reflectivity over particular wavelength ranges and particular angles of incidence, this disclosure contemplates any suitable optical elements having any suitable AR coatings with any suitable reflectivity over any suitable wavelength ranges and any suitable angles of incidence.

FIG. 3 illustrates a top view of an example retroreflector pixel 200. In FIG. 3, retroreflector pixel 200 includes three sub-pixels 310. In particular embodiments, when viewed from above, retroreflector pixel 200 may have a substantially equilateral-triangular shape, and each sub-pixel 310 may have a substantially triangular shape. In particular embodiments, when viewed from above, retroreflector pixel 200 and sub-pixels 310 may each have a substantially triangle shape, square shape, circular shape, elliptical shape, or any other suitable shape. In FIG. 3, example input beam 210 is represented by a circle with a cross, and example output beam 220 is represented by a circle with a dot. Input beam 210 first reflects off a surface of sub-pixel 310Y, then reflects off a surface of sub-pixel 310C, and finally reflects off a surface of sub-pixel 310M, resulting in output beam 220. In particular embodiments, input beam 210 may make a single reflection off of each sub-pixel 310 of retroreflector pixel 200 before exiting from retroreflector pixel 200. In particular embodiments, input beam 210 may be incident on and reflect off of sub-pixels 310 in any suitable order (e.g., first sub-pixel 310C, then sub-pixel 310Y, and finally sub-pixel 310M). In particular embodiments, multiple beams of light may be incident on retroreflector pixel 200 at multiple angles of incidence and each beam may reflect off of sub-pixels 310 of retroreflector pixel 200 in any suitable order.

In particular embodiments, retroreflector pixel 200 may act as a subtractive-color pixel element where retroreflector pixel 200 may selectively filter or remove one or more particular colors or wavelength ranges of light from an incident light source. In particular embodiments, optical filtering of a color or wavelength range of light may be referred to as absorbing, filtering, scattering, or removing a wavelength range of light from an incident beam. In particular embodiments, input beam 210 may be a substantially white-light beam (e.g., light that may include multiple wavelengths across a visible wavelength range), and depending on the configuration of retroreflector pixel 200, output beam 220 may be a substantially white-light beam or may be a colored beam that includes one or more particular wavelengths of light. In particular embodiments, a particular sub-pixel 310 may be configured to selectively filter or reflect a particular color or wavelength range of light, and the combined action of sub-pixels 310 of retroreflector pixel 200 may determine a color and intensity or brightness of retroreflector pixel 200. In particular embodiments, each sub-pixel 310 of retroreflector pixel 200 may be under electronic control, and each sub-pixel 310 may be electrically configured to absorb or reflect an amount of a particular wavelength range of light and reflect light outside the particular wavelength range. In particular embodiments, each sub-pixel 310 may be configured to reflect substantially all or absorb some electronically-controllable amount of a particular primary color (e.g., red, green, or blue) and reflect substantially all of the remaining colors. As an example and not by way of limitation, sub-pixels 310 of retroreflector pixel 200 may be configured to remove or filter out light in red and green wavelength ranges from an incident light source, and as a result, retroreflector pixel 200 may appear as a blue pixel.

In the example of FIG. 3, retroreflector pixel 200 includes three sub-pixels indicated as cyan sub-pixel 310C, magenta sub-pixel 310M, and yellow sub-pixel 310Y. The legend on the right of FIG. 3 provides a guide to the color characteristic of each sub-pixel 310, where a color characteristic indicates a wavelength range of light that sub-pixel 310 is configured to absorb or filter. Sub-pixels 310C, 310M, and 310Y in FIG. 3 are based on a cyan-magenta-yellow (CMY) subtractive-color display technique, where each sub-pixel 310 may be configured to absorb a particular color or wavelength range of light. A CMY subtractive-color display technique may be based on the optical absorption and reflection properties of the three sub-pixels 310C, 310M, and 310Y. A CMY subtractive-color technique employs the concept that the color cyan is the complement of red, the color magenta is the complement of green, and the color yellow is the complement of blue.

In particular embodiments, in a CMY subtractive-color display technique, cyan sub-pixel 310C may act as a filter that absorbs an electrically-controllable amount of light in a red wavelength range and reflects substantially all (e.g., greater than 75% of) light in green and blue wavelength ranges. Similarly, in particular embodiments, magenta sub-pixel 310M may act as an electrically-controllable filter for light in a green wavelength range and may reflect substantially all light in red and blue wavelength ranges. And similarly, in particular embodiments, yellow sub-pixel 310Y may act as an electrically-controllable filter for light in a blue wavelength range and may reflect substantially all light in red and green wavelength ranges. Other subtractive-color display techniques may include red-yellow-blue sub-pixels, violet-orange-green sub-pixels, red-green-blue sub-pixels, or any other suitable combination of colors. Although this disclosure describes and illustrates particular subtractive-color display techniques that include particular colors or wavelength ranges, this disclosure contemplates any suitable subtractive-color display techniques that include any suitable colors or wavelength ranges.

In particular embodiments, sub-pixel 310C may include an absorbing material (e.g., a dye, a glass filter, or a dichroic material) that selectively absorbs red wavelengths and is substantially transmissive or transparent to green and blue wavelengths of light. In particular embodiments, sub-pixel 310C may include an absorbing material that looks or appears as the color cyan, or the color complement of the color red. Similarly, sub-pixel 310M may be configured to reflect substantially all or most of the incident red and blue wavelengths of light while selectively reflecting an electrically-controllable portion of incident green light. In particular embodiments, sub-pixel 310M may include an absorbing material that looks or appears as the color magenta, or the color complement of the color green. Similarly, sub-pixel 310Y may be configured to reflect substantially all or most of the incident red and green wavelengths of light while selectively reflecting an electrically-controllable amount of incident blue light. In particular embodiments, a sub-pixel 310Y may include an absorbing material that looks or appears as the color yellow, or the color complement of the color blue. Although this disclosure describes and illustrates particular retroreflector pixels that include particular sub-pixels configured to selectively absorb or reflect particular colors or wavelength ranges, this disclosure contemplates any suitable retroreflector pixels that include any suitable sub-pixels configured to selectively absorb or reflect any suitable colors or wavelength ranges.

In particular embodiments, a visible wavelength range may refer to optical wavelengths from approximately 400 nm to approximately 700 nm. In particular embodiments, a visible wavelength range may be divided into two, three, four, or any suitable number of wavelength ranges. As an example and not by way of limitation, a visible wavelength range may be divided into three wavelength ranges which may be referred to as a blue wavelength range, a green wavelength range, and a red wavelength range. In particular embodiments, a blue wavelength range of light may correspond to light in a wavelength range from approximately 400 nm to approximately 495 nm. In particular embodiments, a green wavelength range of light may correspond to light in a wavelength range from approximately 495 nm to approximately 570 nm. In particular embodiments, a red wavelength range of light may correspond to light in a wavelength range from approximately 570 nm to approximately 700 nm. Although this disclosure describes and illustrates particular visible wavelength ranges divided into particular numbers of particular wavelength ranges, this disclosure contemplates any suitable visible wavelength ranges divided into any suitable number of any suitable wavelength ranges.

In the example of FIG. 3, sub-pixels 310C, 310M, and 310Y may each include a reflective element or reflective surface that reflects substantially all incident light within the wavelength range of approximately 400 nm to 700 nm. In particular embodiments, a surface that reflects more than 65%, 75%, 85%, or any suitable percentage of light over a particular wavelength range may be referred to as a surface that reflects substantially all incident light. In particular embodiments, a surface that reflects more than 65%, 75%, 85%, or any suitable percentage of light over a particular wavelength range and over a particular range of input angles of incidence may be referred to as a surface that reflects substantially all incident light.

In FIG. 3, cyan sub-pixel 310C may include a filter element that may be electrically controlled or configured so that it absorbs an adjustable amount of light within a red wavelength range of approximately 570 nm to 700 nm. A filter element of sub-pixel 310C may be substantially transparent to visible light that is not in the 570-700 nm wavelength range. As an example and not by way of limitation, a filter element of sub-pixel 310C may have an optical transmission of greater than 80% for light in a wavelength range of approximately 400 nm to approximately 570 nm. Similarly, in FIG. 3, yellow sub-pixel 310Y may include a filter element that may be electrically controlled or configured so that it absorbs an adjustable amount of light within a blue wavelength range of approximately 400 nm to 495 nm. A filter element of sub-pixel 310Y may be substantially transparent (e.g., transmission>80%) to visible light outside a blue wavelength range. As an example and not by way of limitation, a filter element of sub-pixel 310Y may be substantially transparent to light in a wavelength range of approximately 495 nm to 700 nm. And similarly, in FIG. 3, magenta sub-pixel 310M may include a filter element that may be electrically controlled or configured so that it absorbs an adjustable amount of light within a green wavelength range of approximately 495 nm to 570 nm. A filter element of sub-pixel 310M may be substantially transparent (e.g., transmission>80%) to visible light outside a green wavelength range. As an example and not by way of limitation, a filter element of sub-pixel 310M may be substantially transparent to light in the blue wavelength range of approximately 400 nm to 495 nm and light in the red wavelength range of approximately 570 nm to 700 nm. Although this disclosure describes and illustrates particular sub-pixels having particular optical absorption and transmission properties over particular wavelength ranges, this disclosure contemplates any suitable sub-pixels having any suitable optical absorption and transmission properties over any suitable wavelength ranges.

In particular embodiments, each sub-pixel 310 of retroreflector pixel 200 may be electrically controlled or configured so that it filters, absorbs, or reflects between any suitable range of percentages of a particular incident wavelength range. In particular embodiments, sub-pixel 310 may reflect approximately 70-90% of incident light when operating in a full-on state and may reflect approximately 0.5-5% of incident light when operating in a full-off state. As an example and not by way of limitation, depending on a control signal supplied to sub-pixel 310, sub-pixel 310 may reflect from 1% to 90% of incident light within a particular range. As another example and not by way of limitation, sub-pixel may reflect from 3% to 75% of incident light within a particular wavelength range. An on-off contrast ratio (CR) for a retroreflector pixel 200 or for a display that includes an array of retroreflector pixels 200 may be defined as the ratio of maximum power or intensity of light out (e.g., pixel full-on) to minimum power or intensity of light out (e.g., pixel full-off) for a retroreflector pixel 200. In particular embodiments, a retroreflector pixel 200 may have an on:off contrast ratio (CR) of 5:1, 10:1, 20:1, 50:1, 100:1, or any suitable value. As an example and not by way of limitation, a retroreflector pixel 200 may have three sub-pixels 310, and each sub-pixel 310 may have an electrically-controllable range of reflection for a particular wavelength range of from 1.6% to 80%. For example, a particular sub-pixel 310 may reflect approximately R=80% of light in red and green wavelength ranges and may reflect from R=1.6% to 80% of light in a blue wavelength range, depending on a control signal supplied to the sub-pixel 310. When the three sub-pixels 310 are each in a full-on (e.g., fully reflecting) state, then the throughput of the retroreflector pixel 200 will be approximately 51% (=R³=0.8³). When one sub-pixel 310 is configured in a full-off state, then the throughput of the retroreflector pixel 200 for the wavelength range of light associated with the full-off sub-pixel 310 will be approximately 1% (=0.016×0.8²). For such an example retroreflector pixel 200, the contrast ratio may be expressed as CR=I_{MAX}/I_{MIN}=R_{ON}³/(R_{OFF}×R_{ON})=R_{ON}/R_{OFF}=0.8/0.016=/50:1, where I_{MAX} and I_{MIN} are the maximum and minimum power or intensity of light output, respectively, from a retroreflector pixel 200, and R_{ON} and R_{OFF} are the maximum and minimum electrically-controllable reflectivities, respectively, of a sub-pixel 310. For the above example, a retroreflector pixel 200 with three sub-pixels 310 that each reflect from 1.6% to 80% of incident light within particular wavelength ranges has an on:off contrast ratio of 50:1. Although this disclosure describes and illustrates particular sub-pixels with particular percentage ranges of electrically-controllable absorption or reflection, this disclosure contemplates any suitable sub-pixels having any suitable percentage ranges of electrically-controllable absorption or reflection. Moreover, although this disclosure describes and illustrates particular pixels having particular contrast ratios, this disclosure contemplates any suitable pixels having any suitable contrast ratios.

In particular embodiments, sub-pixel 310C may be configured to reflect substantially all (e.g., greater than 80% of) incident light in green and blue wavelength ranges while absorbing an electrically-controllable amount of light in a red wavelength range. In particular embodiments, the electrically-controllable amount or percentage of light in a particular wavelength range that is absorbed or reflected by sub-pixel 310 may be determined by a control signal (e.g., a voltage, electric field, or current) applied to a part of sub-pixel 310, such as for example an electrode of sub-pixel 310. In particular embodiments, applying a particular control signal to sub-pixel 310C may result in a particular amount of the incident red light being absorbed and a particular amount of the incident red light being reflected (e.g., from 2% to 80%) by sub-pixel 310C. As an example and not by way of limitation, if little or no control signal is applied to sub-pixel 310C, sub-pixel 310C may reflect substantially all (e.g., greater than 80% of) incident light in a red wavelength range. As another example and not by way of limitation, a control signal may be applied to sub-pixel 310C that results in approximately 40% of incident red light being reflected. As another example and not by way of limitation, a control signal may be applied to a red sub-pixel that results in approximately 98% of the incident red light being absorbed and approximately 2% of the incident red light being reflected. A retroreflector pixel 200 that includes three such example sub-pixels 310 would have a contrast ratio of CR=80%/2%=40:1. In particular embodiments, the amount of incident light on sub-pixel 310 may approximately equal the amount of reflected light plus the amount of absorbed or filtered light of sub-pixel 310. As an example and not by way of limitation, for a beam with approximately 100 nW of optical power in a red wavelength range incident on sub-pixel 310C, sub-pixel 310C may be configured so that approximately 40 nW of incident red light is reflected and approximately 60 nW of incident red light is scattered, filtered, or absorbed.

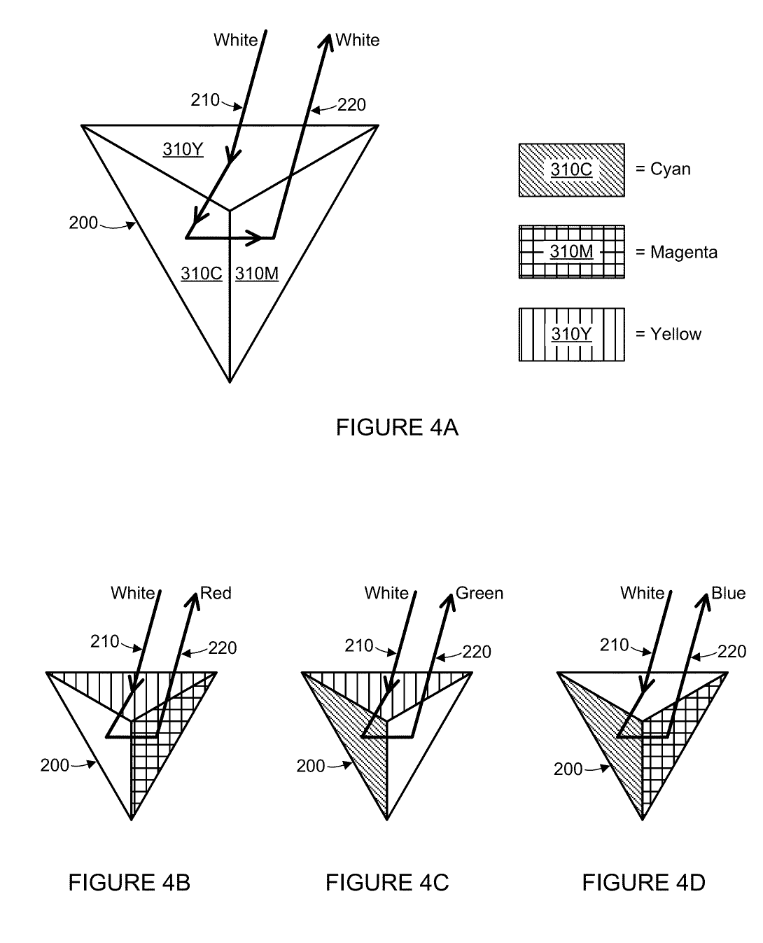

FIG. 4 illustrates example color configurations of example retroreflector pixels 200. As in FIG. 3, the legend on the right of FIG. 4A provides a guide to the color characteristic of each sub-pixel 310. In the example of FIG. 4, a white or un-hatched sub-pixel 310 indicates a sub-pixel 310 configured to reflect substantially all incident light in a visible wavelength range, and a hatched sub-pixel 310 indicates a sub-pixel 310 configured to absorb or filter light in a particular wavelength range. As an example and not by way of limitation, sub-pixel 310Y in FIG. 4A is configured to reflect substantially all incident light in a visible wavelength range, while sub-pixel 310Y in FIG. 4B is configured to absorb or filter substantially all light in a blue wavelength range and reflect substantially all light in red and green wavelength ranges. In particular embodiments, when each sub-pixel 310 of a retroreflector pixel 200 is configured to reflect substantially all incident light in a visible wavelength range, retroreflector pixel 200 may appear white. In particular embodiments, when each sub-pixel 310 of a retroreflector pixel 200 is configured to filter out substantially all of their associated wavelength ranges from an incident beam, retroreflector pixel 200 may appear dark or black.

In the example of FIG. 4A, cyan sub-pixel 310C, magenta sub-pixel 310M, and yellow sub-pixel 310Y are each configured to reflect substantially all light in a visible wavelength range. In FIG. 4A, incident beam 210 may be a white-light beam, and since all sub-pixels are configured to reflect substantially all light in a visible wavelength range, output beam 220 may be a white-light beam. Retroreflector pixel 200 in FIG. 4A may appear white when illuminated with a white-light source.

In particular embodiments, sub-pixel 310 of retroreflector pixel 200 may reflect less than 100% of incident light when sub-pixel 310 is configured to reflect substantially all incident light. As an example and not by way of limitation, when sub-pixel 310 is configured to reflect substantially all incident light, sub-pixel 310 may reflect approximately 80% of incident light, corresponding to an ambient loss of sub-pixel 310 of approximately 20% (=100%−80%). In particular embodiments, ambient loss of sub-pixel 310 may refer to sources of optical loss of sub-pixel 310 that are present regardless of an electrically-configured state of sub-pixel 310. In particular embodiments, sources of ambient loss may include one or more of the following: sub-pixel 310 reflective surface having a reflectivity of less than 100%; optical scattering within bulk optical elements of sub-pixel 310; or non-zero reflectivity of optical surfaces or interfaces, such as for example AR-coated surfaces.

As an example and not by way of limitation, sub-pixel 310 may include a reflective surface with a reflectivity of approximately 85% (corresponding to an optical loss of approximately 15%), optical elements with a combined scatter loss of approximately 4%, and two AR-coated surfaces each with a reflectivity of approximately 1%. For such an example sub-pixel 310, the total optical transmission or throughput may be defined as the product of the throughput of each individual optical element, resulting in an optical throughput for sub-pixel 310 of approximately 0.85×0.96×0.99×0.99≅0.80, or 80%. Such an example sub-pixel 310 then has a reflectivity of approximately 80% and a corresponding optical loss of 100%−80%=20%. If each sub-pixel 310 of retroreflector pixel 200 has reflectivity of approximately 80% when each sub-pixel 310 is configured to reflect substantially all incident light (e.g., operating in a full-on state), then an optical throughput for retroreflector pixel 200 may be calculated from P_{OUT}/P_{IN}=R^{N}=(0.80)³≅51%, where P_{OUT} represents the output optical power of output beam 220, P_{IN} represents the input optical power of input beam 210, N is the number of reflections or sub-pixels 310, and R represents the reflectivity of each sub-pixel 310. For the example retroreflector pixel 200 of FIG. 4A, input beam 210 with approximately 100 nW of white-light optical power may exit retroreflector pixel 200 with output beam 220 having approximately 51 nW of white-light optical power. In particular embodiments, a retroreflector pixel 200 may have a maximum optical throughput (e.g., ratio of output optical power to input optical power) of approximately 20%, 35%, 50%, or any suitable value.

In the example of FIG. 4B, cyan sub-pixel 310C is configured to reflect substantially all light in a visible wavelength range, while magenta sub-pixel 310M and yellow sub-pixel 310Y are configured to filter out substantially all light in green and blue wavelength ranges, respectively. As illustrated in FIG. 4B, a white-light input beam 210 may have green and blue wavelength components filtered out resulting in a red output beam 220. Retroreflector pixel 200 in FIG. 4B is configured to appear red when illuminated with a white-light source.

In the example of FIG. 4C, magenta sub-pixel 310M is configured to reflect substantially all light in a visible wavelength range, while cyan sub-pixel 310C and yellow sub-pixel 310Y are configured to filter out substantially all light in red and blue wavelength ranges, respectively. As illustrated in FIG. 4C, a white-light input beam 210 may have red and blue wavelength components filtered out resulting in a green output beam 220. Retroreflector pixel 200 in FIG. 4C is configured to appear green when illuminated with a white-light source.

In the example of FIG. 4D, yellow sub-pixel 310Y is configured to reflect substantially all light in a visible wavelength range, while cyan sub-pixel 310C and magenta sub-pixel 310M are configured to filter out substantially all light in red and green wavelength ranges, respectively. As illustrated in FIG. 4D, a white-light input beam 210 may have red and green wavelength components filtered out resulting in a blue output beam 220. Retroreflector pixel 200 in FIG. 4D is configured to appear blue when illuminated with a white-light source. In particular embodiments, retroreflector pixel 200 may not be limited to appearing as white, dark, or a primary color (e.g., red, green, or blue). In particular embodiments, retroreflector pixel 200 may be configured to appear as a variety of spectral colors or shades by modulating the filtering or absorption of each sub-pixel 310 of retroreflector pixel 200 accordingly. As an example and not by way of limitation, retroreflector pixel 200 may be configured to appear yellow when sub-pixels 310C and 310M are configured to reflect substantially all light in a visible wavelength range and sub-pixel 310Y is configured to filter out substantially all light in a blue wavelength range. In particular embodiments, a full-spectrum of colors may be made to appear by modulating the absorption or reflection of particular sub-pixels 310 to states between their full-on and full-off states. As an example and not by way of limitation, retroreflector pixel 200 may be configured to appear orange when sub-pixel 310C is configured to reflect substantially all light in a visible wavelength range, sub-pixel 310M is configured to reflect approximately 50% of incident green light, and sub-pixel 310Y is configured to filter out substantially all light in a blue wavelength range. Although this disclosure describes and illustrates particular retroreflector pixels configured to appear as particular colors, this disclosure contemplates any suitable retroreflector pixels configured to appear as any suitable colors.

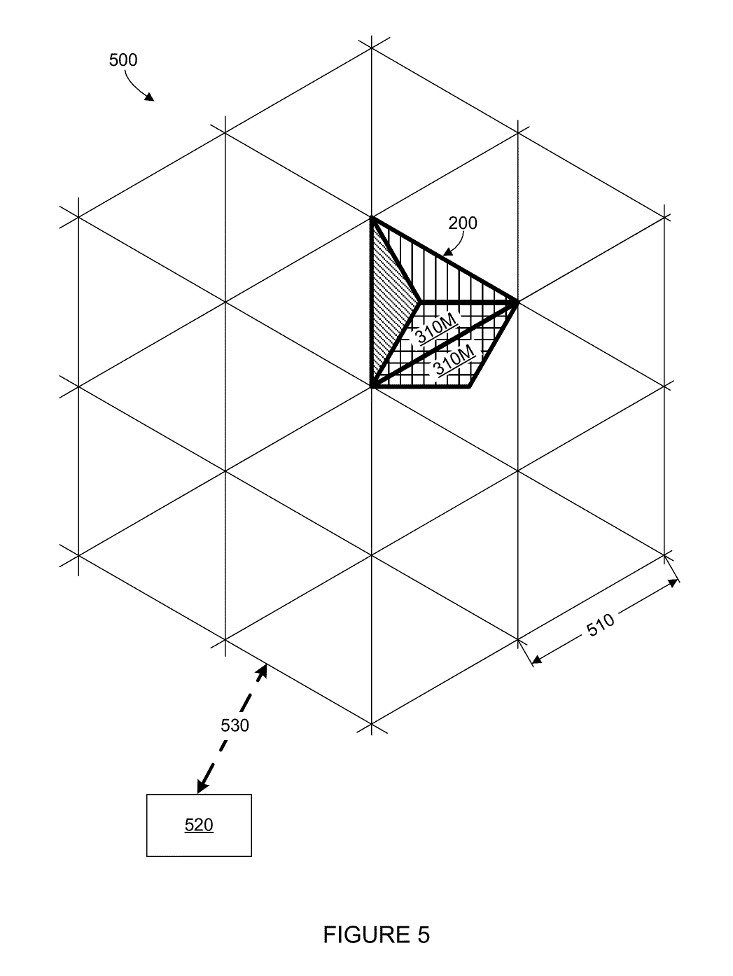

FIG. 5 illustrates an example portion 500 of an example display that includes example retroreflector pixels 200 arranged in an array. In particular embodiments, a display screen (or, display) may refer to a display device that presents or displays visual information (e.g., text, images, or videos). In particular embodiments, a computing device may include one or more integrated display screens. In particular embodiments, a display may include multiple retroreflector pixels 200 arranged in an array and may present visual information in the form of text, images, or videos. In particular embodiments, a display that includes retroreflector pixels 200 may be referred to as a retroreflective display, a retroreflector display, or a reflective display. In particular embodiments, a display that includes retroreflector pixels 200 may not include a built-in illumination source or light source, such as for example a display backlight. In particular embodiments, a retroreflector display may provide display functionality in ambient light, and such an ambient-light display may use any suitable source of ambient light as an illumination source for the display. In particular embodiments, ambient light may refer to direct illumination from room light or sunlight, indirect illumination from scattered room light or sunlight, or any suitable source of illumination or combination of suitable illumination sources. In particular embodiments, a retroreflector display may include a built-in illumination source or light source. In particular embodiments, a built-in light source may be front-mounted so that light enters into retroreflector pixels 200 from the viewing side of a display. Although this disclosure describes and illustrates particular retroreflector displays having particular illumination sources, this disclosure contemplates any suitable retroreflector displays having any suitable illumination sources.

In particular embodiments, a retroreflector display may include an array of multiple retroreflector pixels 200 arranged across a display screen in a regular or repeating pattern. As illustrated by display portion 500 of FIG. 5, retroreflective pixel elements 200 may be arrayed on a hexagonal grid to form a retroreflector display. In particular embodiments, retroreflector pixel 200 may refer to a single display element of a display screen. In particular embodiments, each retroreflector pixel 200 may act as a single pixel of a display, and each retroreflector pixel 200 may be capable of displaying a particular color (e.g., red, orange, yellow, green, blue, purple, or any suitable color) including a substantially black, white, or gray color. In particular embodiments, a display may include an array of retroreflector pixels 200 that occupy substantially most or all of a display surface. In particular embodiments, approximately 70%, 80%, 90%, or any suitable percentage of a surface area of a retroreflective display may be used to retroreflect available light. In particular embodiments, a retroreflector pixel may have a characteristic size or dimension 510 (e.g., length or width) of approximately 50 μm, 100 μm, 200 μm, 1 mm, 1 cm, 5 cm, 10 cm, or any suitable size or dimension. Although this disclosure describes and illustrates particular displays that include particular retroreflector pixels having particular sizes and in particular arrangements, this disclosure contemplates any suitable displays that include any suitable retroreflector pixels having any suitable sizes and in any suitable arrangements.

In particular embodiments, a retroreflector display may present visual information in color. Such a color display may be capable of displaying text, images, or videos composed of one or more colors (e.g., red, orange, yellow, green, blue, purple, or any suitable color or combination of colors) as well as black, white, and gray. In particular embodiments, a retroreflector display may present text, images, or videos in color, black-and-white, or grayscale format by selectively absorbing or filtering out particular colors or wavelengths of light from an ambient light source. In particular embodiments, each retroreflector pixel 200 of a retroreflective display may be configured to selectively absorb or filter particular color components or wavelength ranges from incident ambient light. In particular embodiments, a retroreflective color display may include a display capable of displaying information in color as well as black, white, and grayscale.

In particular embodiments, electrical control for retroreflector pixels 200 or sub-pixels 310 of a retroreflector display may be provided by display controller 520. In particular embodiments, display controller 520 may be coupled to retroreflector pixels 200 or sub-pixels 310 of a retroreflector display by coupling line 530. In particular embodiments, coupling line 530 may provide electrical coupling between display controller 520 and retroreflector pixels 200 or sub-pixels 310 of a retroreflector display, and coupling line 530 may include electrical wiring, conductive traces of a printed-circuit board, conductive lines of a flexible printed circuit, electrical connectors, or any suitable conductive element, or any suitable combination thereof. In particular embodiments, coupling line 530 may include a backplane or an electrical multiplexer that couples drive signals or control signals from display controller 520 to retroreflector pixels 200 or sub-pixels 310. In particular embodiments, display controller 520 may provide drive signals or control signals to retroreflector pixels 200 or sub-pixels 310 to electrically configure, drive, or control the state or configuration of retroreflector pixels 200 or sub-pixels 310. In particular embodiments, a retroreflector-array display may be configured so that electrical power may be consumed primarily when a display is changing its display state. In particular embodiments, a retroreflector-array display may be configured so that when the display is in a static state (e.g., displaying a fixed image or page of text), the display is consuming substantially little or no electrical power.

In particular embodiments, display controller 520 may be operable to control the filter elements of each retroreflector sub-pixel 310 of a display. In particular embodiments, at a particular time, the logic operable to control the filter elements of each retroreflector sub-pixel 310 may alternately control each sub-pixel 310, may control some subset of sub-pixels 310, or may control no sub-pixels. In particular embodiments, when the logic operable to control sub-pixels 310 is controlling no sub-pixels 310, sub-pixels 310 may be in a fully-reflecting state where sub-pixels 310 are configured to reflect substantially all incident light. In particular embodiments, when the logic operable to control sub-pixels 310 is controlling no sub-pixels 310, sub-pixels 310 may be in a fully-filtering or fully-absorbing state where sub-pixels 310 are configured to filter or absorb substantially all incident light.

Display controller 520 may be one or more integrated circuits (ICs), such as for example general-purpose microprocessors, microcontrollers, programmable logic devices or arrays, or application-specific ICs (ASICs). In particular embodiments, display controller 520 may include analog circuitry, digital logic, and digital non-volatile memory. In particular embodiments, display controller 520 may be integrated with other circuitry or devices of a computing device, such as for example a graphics card or a graphics device of a computing device. Although this disclosure describes a particular display controller having particular functionality with respect to a retroreflector display, this disclosure contemplates any suitable display controller having any suitable functionality with respect to any suitable retroreflector display.

In particular embodiments, a controller cell for a circuit design for display controller 520 may be provided by an EDA system. The controller cell provided by an EDA system may be operable to control one or more retroreflector pixels 200 or one or more retroreflector sub-pixels 310. As an example and not by way of limitation, the controller cell may be operable to apply a voltage to an electrode of sub-pixel 310 to control an amount of light over a particular wavelength range that sub-pixel 310 filters out from an incident light source. As another example and not by way of limitation, the controller cell provided by the EDA system may be operable to apply a drive signal or a control signal to an actuator coupled to sub-pixel 310.

In particular embodiments, retroreflective display 500 may include multiple retroreflector pixels 200 that each may be addressed, controlled, or configured individually to display or reflect a particular color. In particular embodiments, each retroreflector pixel 200 of a display may be configured to display or reflect a particular color of incident light at a particular time, and at a later time, each retroreflector pixel 200 may be re-configured to reflect a different color of incident light. In particular embodiments, each retroreflector pixel 200 of a display may be dynamically controlled so that its displayed color can be changed over time. In particular embodiments, a configuration or state of retroreflector pixel 200 may be dynamically changed or updated with an update frequency or refresh rate of approximately 25 Hz, 30 Hz, 50 Hz, 60 Hz, or any suitable frequency.

In particular embodiments, electronic control of two or more adjacent, same-color sub-pixels 310 may be combined at a conjunction of adjacent retroreflector pixels 200. In particular embodiments, retroreflector pixels 200 may be arranged so that some pairs of sub-pixels 310 adjacent across pixel boundaries may be assigned the same color. In the example of FIG. 5, two magenta sub-pixels 310M are located adjacent to each other, and in particular embodiments, these two sub-pixels may be coupled together so that they may be electrically controlled with a single control line. In particular embodiments, coupling together adjacent pairs of same-color sub-pixels may allow two adjacent sub-pixels to be controlled as one and thus reduce the amount of electrical wiring, circuitry, or connections for a particular display. In particular embodiments, light-modulating structures for two adjacent same-color sub-pixels may be similarly combined or coupled together so that one light-modulating structure may be used to control two adjacent sub-pixels as one sub-pixel. In particular embodiments, a light-modulating structure may refer to an optical device that is part of, integrated with, or attached to a sub-pixel and is configured to modulate a color reflected from the sub-pixel.

In particular embodiments, electrical or mechanical elements to control, drive, or couple to retroreflector pixels 200 may be located behind the retroreflective display surface and thereby may not block or interfere with light incident on or reflected from the display. In particular embodiments, display controller 520 may be integrated as part of a display, and display controller 520 may be located behind the display surface. In particular embodiments, a retroreflective display and its display controller 520 may be located separate from each other and may be coupled together by coupling line 530. In particular embodiments, a retroreflective display may be integrated into any suitable device, such as, for example and without limitation, a desktop computer, laptop computer, e-Reader, personal digital assistance, smartphone, satellite navigation device, portable media player, portable game console, electronic sign, electronic billboard, instrument panel, or other suitable device.

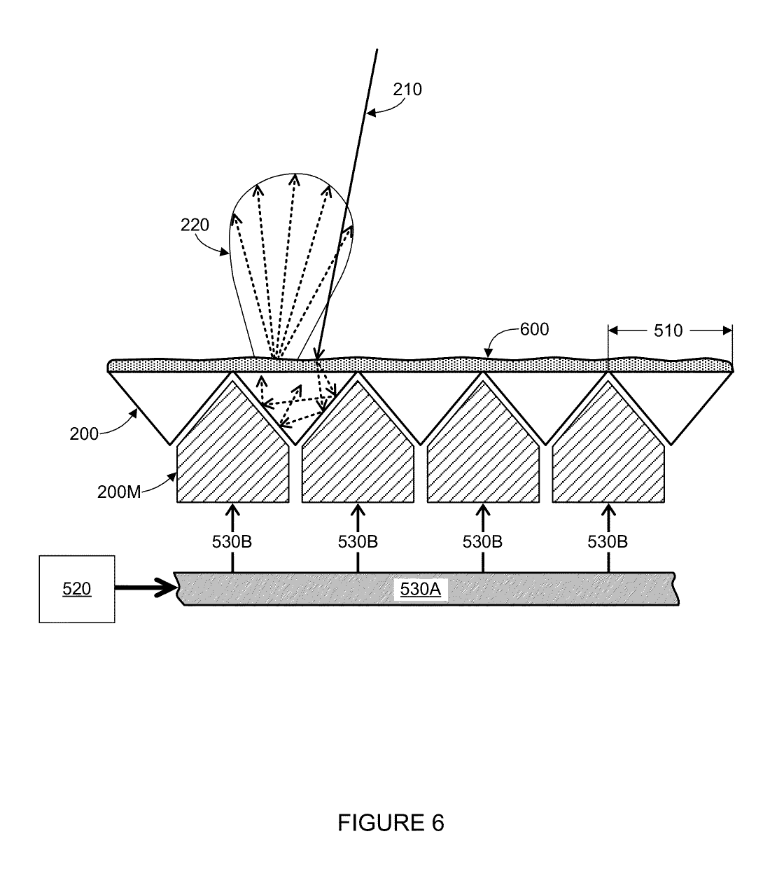

FIG. 6 illustrates a side view of an example array of retroreflector pixels 200. In FIG. 6, the array of retroreflector pixels 200 may be part of a retroreflector display, and each retroreflector pixel 200 or sub-pixel 310 may include one or more light-modulating structures 200M. In the example of FIG. 6, two adjacent sub-pixels 310 may be associated with one light-modulating structure 200M that controls the two adjacent sub-pixels as one sub-pixel. In particular embodiments, each light-modulating structure 200M may be coupled to display controller 520 by coupling line 530. In FIG. 6, coupling line includes a backplane or multiplexer 530A and control-signal connectors 530B. Display controller 520 is coupled to backplane or multiplexer 530A which is in turn coupled to control-signal connectors 530B, and each control-signal connector 530B is coupled to a light-modulating structure 200M. In particular embodiments coupling line 530 may provide a control or drive signal from display controller 520 to each light-modulating structure 200M that electrically controls an amount of light over a particular wavelength range that sub-pixel 310 may filter out from incident beam 210.

In the example of FIG. 6, a cover material 600 may be deposited on or attached to a top surface of the retroreflector display. In particular embodiments, cover material 600 may be made from glass, a dielectric material, plastic, polymer, or any suitable optically-transparent material that is substantially transparent to visible light. In particular embodiments, cover material 600 may be non-uniform, may have variations in thickness, or may have a particular amount of surface roughness or surface texturing. In particular embodiments, cover material 600 may be substantially flat, may have a smooth surface texture, or may be uniform with a substantially constant thickness. In particular embodiments, cover material 600 may have one or more surfaces with an AR coating. In particular embodiments, cover material 600 may include a protective coating or sealant that covers and protects the retroreflector display. In particular embodiments, cover material 600 may include a thin-film material deposited onto a top surface of a retroreflector display. Although this disclosure describes and illustrates particular retroreflector displays with particular cover materials, this disclosure contemplates any suitable retroreflector displays with any suitable cover materials.

In particular embodiments, cover material 600 may include a transparent diffuser material or an array of microlenses, where a diffuser material or array of microlenses may be configured to spread out reflected light beam 220 relative to incident illumination beam 210. In particular embodiments, a diffuser material or array of microlenses, by spreading out reflected beam 220, may act to widen the viewing angle of a retroreflector display. In particular embodiments, a diffuser or an array of microlenses may act to optimize viewing angles or brightness of a display. In particular embodiments, a transparent diffuser may include an optical material (e.g., ground glass, opal diffusing glass, or holographic diffuser) that produces an angularly spread-out transmitted light beam from an incident illumination beam 210. Although this disclosure describes and illustrates particular transparent diffuser materials, this disclosure contemplates any suitable transparent diffuser materials. In particular embodiments, a microlens array may include an array of microlenses arranged to approximately coincide with an array of retroreflector pixels 200. In particular embodiments, each microlens may be associated with or positioned above a single retroreflector pixel 200. In particular embodiments, two or more microlenses may be associated with or positioned above a single retroreflector pixel 200. In particular embodiments, a microlens array may include an array of microlenses arranged in a random or pseudo-random pattern with respect to the array of retroreflector pixels 200. In particular embodiments, such a random or pseudo-random arrangement of microlenses may substantially reduce Moiré-pattern effects that may result from superimposing a microlens pattern onto a pixel array. Although this disclosure describes and illustrates particular microlenses having particular arrangements with respect to a retroreflector pixel array, this disclosure contemplates any suitable microlenses having any suitable arrangement with respect to a retroreflector pixel array.

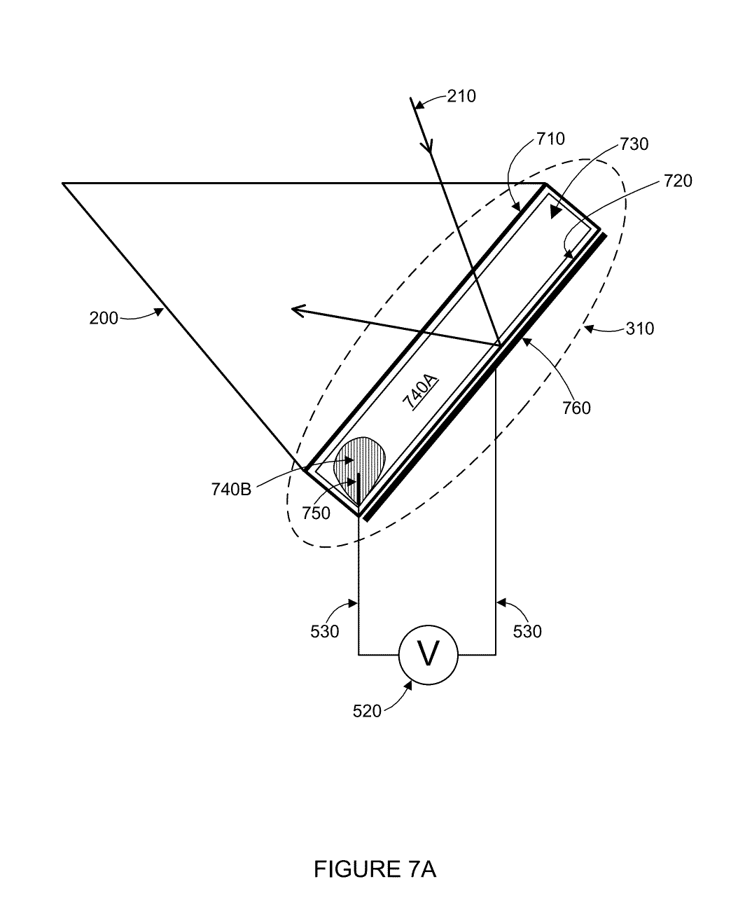

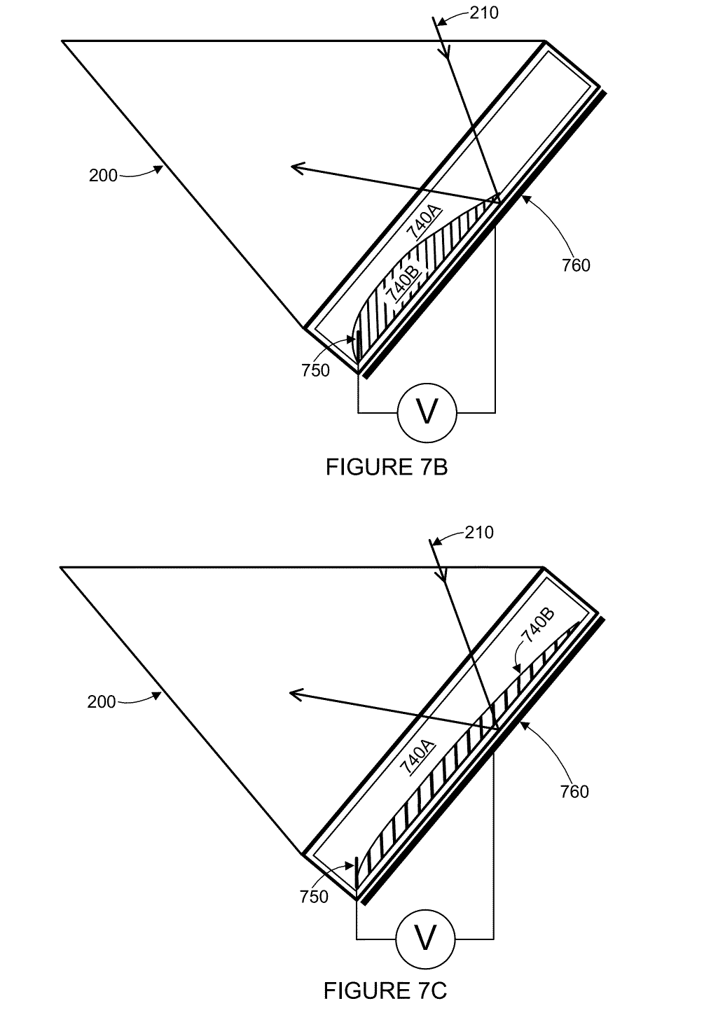

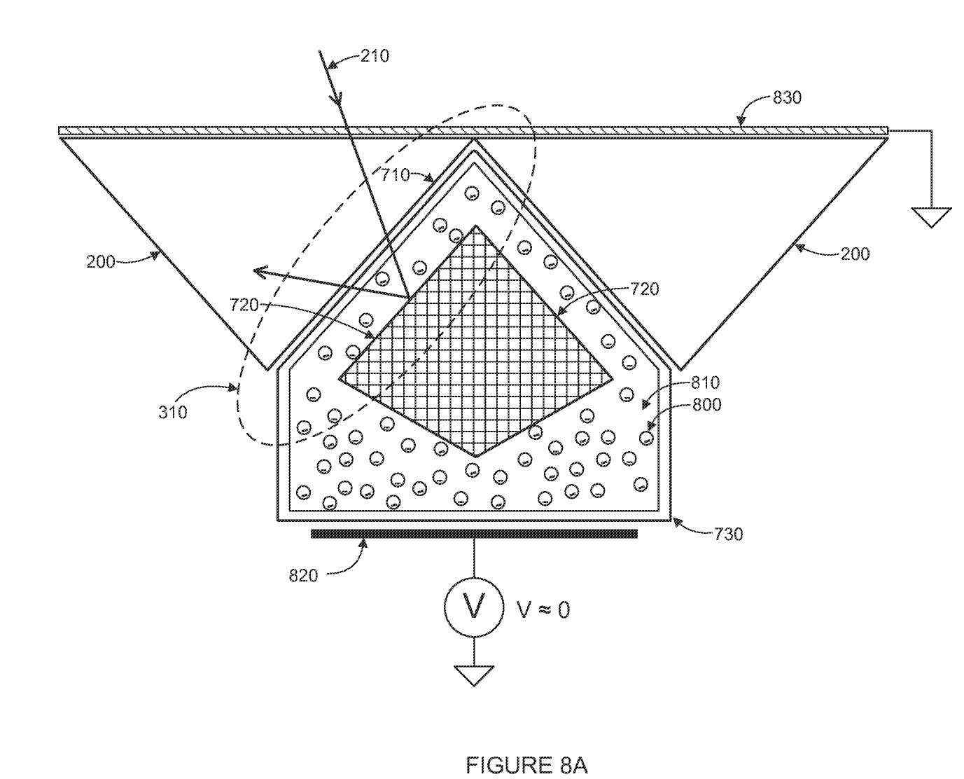

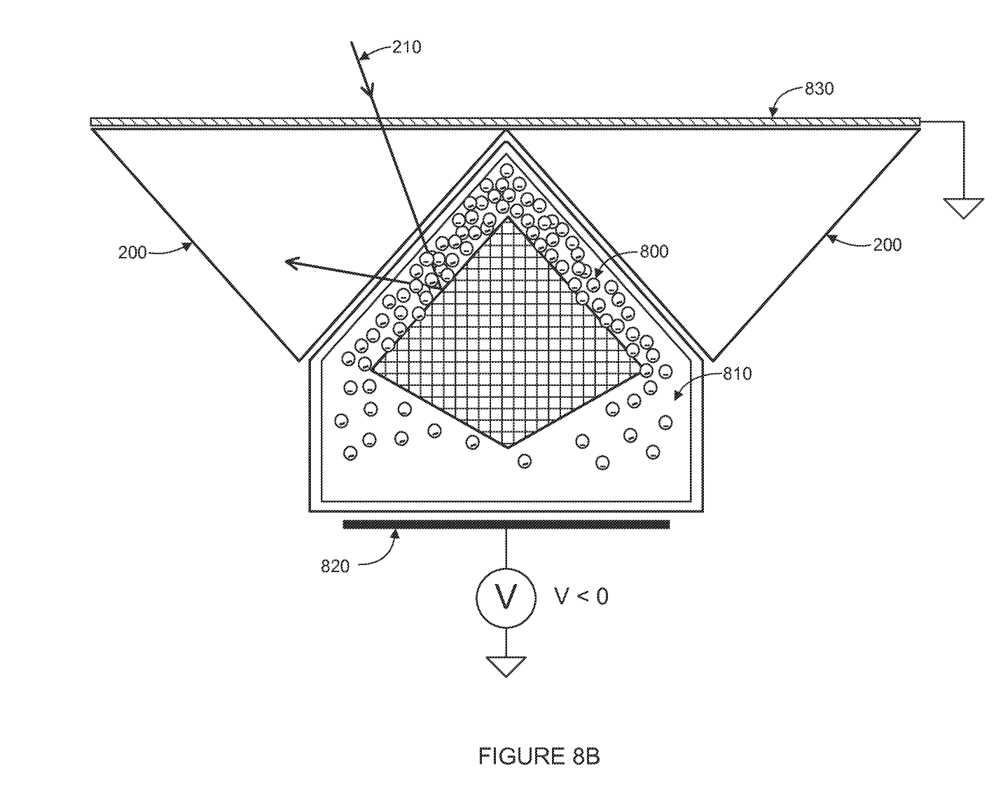

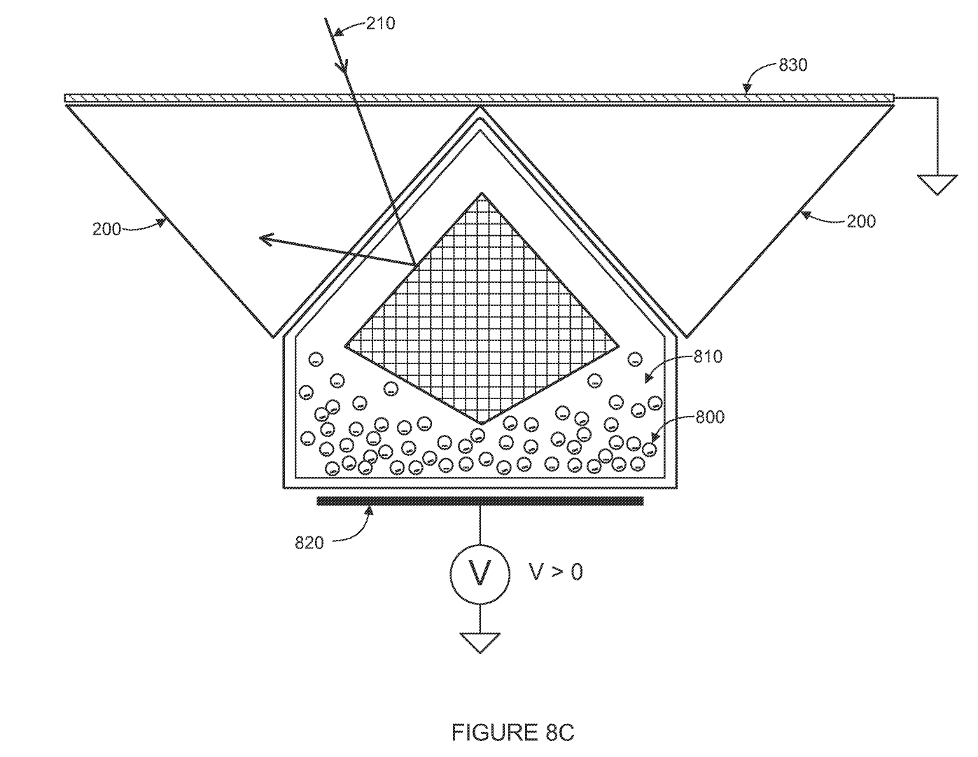

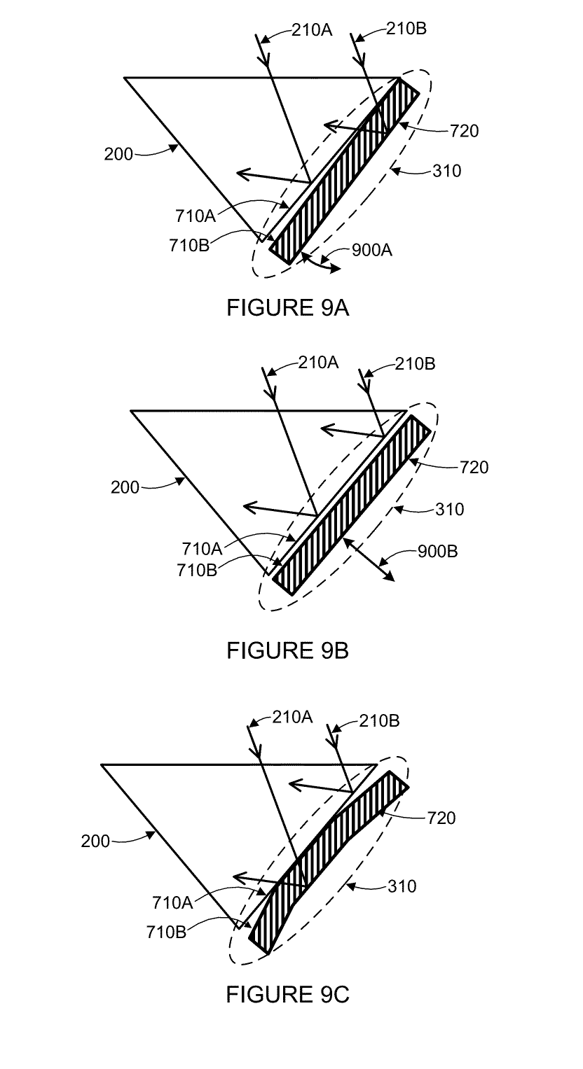

FIGS. 7A-7C illustrate an example retroreflector pixel 200 where a dye may be used to modulate the color reflected from an example sub-pixel 310. In the example of FIGS. 7A-7C, modulating the reflected light color of incident beam 210 involves an electrowetting technique where a fluid between sub-pixel 310 front face 710 and reflecting back surface 720 can be modulated between clear (e.g., substantially transparent) and colored (e.g., absorbing). In particular embodiments, retroreflector pixel 200 may include three or more sub-pixels 310, but for clarity of illustrating and describing the operation of sub-pixel 310, in FIGS. 7A-7C (as well as FIGS. 8A-8C and 9A-9C), a single sub-pixel 310 is described or illustrated. In FIGS. 7A-7C, retroreflector pixel 200 may include a substantially-hollow interior volume that sub-pixel 310 is arranged adjacent to. In particular embodiments, front surface 710 of sub-pixel 310 may have an AR coating applied to it. In FIGS. 7A-7C, sub-pixel 310 includes a chamber 730 made of substantially-transparent material (e.g., glass or plastic), and front surface 710 of sub-pixel 310 is attached or optically contacted to chamber 730. Chamber 730 contains two immiscible fluids 740A and 740B, such as for example, oil and water or a water-based electrolyte. In particular embodiments, inner surfaces of chamber 730 are made of or coated with a hydrophobic material so that water does not want to stick to the surfaces. In particular embodiments, fluid 740A may be an oil that is substantially transparent to visible light, and fluid 740B may be a water-based electrolyte that is dyed to absorb a particular wavelength range of light. As an example and not by way of limitation, fluid 740B may include a dye that selectively absorbs a particular wavelength range of visible light (e.g., green) while being substantially transparent to other wavelength ranges of visible light (e.g., red and blue). In particular embodiments, retroreflector pixel 200 may include three sub-pixels 310, and each sub-pixel 310 may include a fluid 740B that is dyed with a material that absorbs red, green, or blue wavelengths of light, respectively.

In FIGS. 7A-7C, a voltage, electric field, or electric current is applied to electrolyte fluid 740B by two electrodes 750 and 760. In particular embodiments, electrode 750 may penetrate into chamber 730, and electrode 760 may be a metallic film or a metal plate positioned on or near back surface 720. In particular embodiments, electrode 760 may be a thin-film metallic coating (e.g., gold, aluminum, or silver) deposited on a surface of chamber 730, and such an electrode may also function as a reflective back surface 720. In particular embodiments, a control signal (e.g., a voltage or current) may be supplied to electrodes 750 and 760 by display controller 520 which may be coupled to electrodes 750 and 760 through coupling line 530. In FIG. 7A, the applied voltage (V) is approximately zero. With no applied voltage, the electrolyte fluid 740B's surface tension relaxes it into a near-spherical shape, and electrolyte fluid 740B is substantially out of the light path. In particular embodiments, when little or none of dyed electrolyte fluid 740B is located in a light path of sub-pixel 310, most or substantially all (e.g., 80% or more) of incident light 210 may be reflected by reflective back surface 720. In FIG. 7A, input beam 210 travels through chamber 730 and reflects off of reflecting surface 720 without substantial optical absorption, and sub-pixel 310 is in a full-on, or maximum reflection, state. In FIG. 7B, a moderate voltage (V) is applied between electrodes 750 and 760, and electrostatic forces attract electrolyte fluid 740B to electrode 760, causing electrolyte fluid 740B to spread out into the light path. In FIG. 7B, sub-pixel 310 is in a partially-on, or partially-absorbing, state. In particular embodiments, as the amount or concentration of electrolyte fluid 740B located in sub-pixel 310 light path is increased by changing a voltage applied to electrodes 750 and 760, the amount of absorption of a particular wavelength range will similarly increase. In FIG. 7C, the applied voltage (V) is increased, and the increasing voltage further counteracts the surface-tension forces, causing electrolyte fluid 740B to spread out further into the light path. In FIG. 7C, electrolyte fluid 740B may cause most of a particular wavelength range of input beam 210 to be absorbed, and sub-pixel 310 may be in a full-off, or maximum absorption, state. When the applied voltage (V) is removed or reduced to zero, surface tension will cause electrolyte fluid 740B to relax back out of the light path, as illustrated in FIG. 7A. Although this disclosure describes and illustrates a particular retroreflector pixel based on a particular electrowetting modulation technique, this disclosure contemplates any suitable retroreflector pixel based on any suitable electrowetting modulation technique.

FIGS. 8A-8C illustrate an example retroreflector pixel 200 where an electrophoretic technique may be used to modulate the color reflected from an example sub-pixel 310. In particular embodiments, particles or beads 800 that are dyed or colored to absorb a particular wavelength range and that have an electrostatic charge may be moved into and out of a sub-pixel 310 light path by an applied electric field. In particular embodiments, charged particles 800 may be colored or filled with an optical-filter material so that they absorb or scatter a color or wavelength range of visible light while being substantially transparent to other wavelength ranges of visible light. In particular embodiments, charged particles 800 may have a refractive index that is close to (e.g., within 10% of) the refractive index of fluid 810 to minimize refractive scattering of incident beam 210. In particular embodiments, charged particles 800 may be suspended as a colloidal solution in a non-conductive (or dielectric) fluid 810. In particular embodiments, charged particles 800 may be made of a dielectric material, such as for example polystyrene or poly(methyl methacrylate) (PMMA), and fluid 810 may be mineral oil. This disclosure contemplates any suitable charged particles suspended in any suitable fluids. In particular embodiments, the size and concentration of charged particles 800 may be sufficient to filter out a particular amount (e.g., 98%) of light in a particular wavelength range from incident beam 210 when charged particles 800 are drawn into the light path. In particular embodiments, charged particles 800 may have a sufficient electrostatic charge to maintain a colloidal separation among them through a repulsive electrostatic force. In the example of FIGS. 8A-8C, charged particles 800 have a negative electrostatic charge. In particular embodiments, charged particles 800 may have a positive or a negative electric charge. In particular embodiments, charged particles 800 and fluid 810 may have a density that is substantially the same (e.g., within 10%) to minimize effects of gravitational or other mechanical forces on charged particles 800.

In FIGS. 8A-8C, charged particles 800, fluid 810, and reflective surface 720 are contained within chamber 730. In particular embodiments, walls or surfaces of chamber 730 may have an AR coating applied to them. In particular embodiments, walls or surface of chamber 730 may be attached or optically contacted to surface 710. In FIGS. 8A-8C, a voltage or electric field may be applied between electrodes 820 and 830. In particular embodiments, electrode 820 may be a metal plate or a thin-film of metal deposited onto a surface of chamber 730. In particular embodiments, electrode 830 may be a transparent, electrically-conductive material, such as for example, a thin-film of indium tin oxide (ITO) deposited onto a top surface of pixel 200. A control voltage (V) may be supplied to electrodes 820 and 830 by display controller 520 which may be coupled to electrodes 820 and 830 through coupling line 530.

In FIG. 8A, the control voltage V is approximately zero, and charged particles 800 are evenly distributed throughout fluid 810. In FIG. 8A, some amount of charged particles 800 are in the beam path, and sub-pixel 310 is in a partially-on, or partially-absorbing, state. In FIG. 8B, the control voltage V is set to a negative value so that electrode 820 has a negative potential that repels the negatively-charged particles 800. The charged particles 800 are repelled away from electrode 820 and drawn into the beam path. In FIG. 8B, optically-absorbing charged particles 800 may cause most of a particular wavelength range of input beam 210 to be absorbed, and sub-pixel 310 may be in a full-off, or maximum absorption, state. In FIG. 8C, the control voltage V is set to a positive value so that electrode 820 has a positive potential that attracts the negatively-charged particles 800. The charged particles 800 are attracted toward electrode 820 and drawn out of the beam path. In FIG. 8C, with little or no optically-absorbing charged particles 800 located in a light path of sub-pixel 310, most or substantially all (e.g., 80% or more) of incident light may be reflected by reflective surface 720. In FIG. 8C, input beam 210 travels through chamber 730 and reflects off of reflective surface 720 without substantial optical absorption, and sub-pixel 310 is in a full-on, or maximum reflection, state. In particular embodiments, as the amount or concentration of optically-absorbing charged particles 800 located in the beam path is changed by changing applied voltage V, the amount of absorption of a particular wavelength range of light may be modulated. Although this disclosure describes and illustrates a particular retroreflector pixel based on a particular electrophoretic modulation technique, this disclosure contemplates any suitable retroreflector pixel based on any suitable electrophoretic modulation technique.

FIGS. 9A-9C illustrate an example retroreflector pixel 200 where an evanescent-wave coupling technique may be used to modulate the color reflected from an example sub-pixel 310. In particular embodiments, sub-pixel 310 may include a filter plate with front surface 710B and back surface 720. In particular embodiments, the filter plate of sub-pixel 310 may be configured to absorb a particular wavelength range of visible light while being substantially transparent to other wavelength ranges of visible light. In FIGS. 9A-9C, back surface 720 may be a reflective surface that reflects substantially all light in a visible wavelength range. In FIGS. 9A-9C, front surface 710B of filter plate may be positioned near surface 710A of retroreflector pixel 200. In particular embodiments, retroreflector pixel 200 may include a solid interior volume made from glass, plastic, or any suitable substantially-transparent material. In particular embodiments, surfaces 710A and 710B may have no dielectric coating or may each have any suitable dielectric coating. In particular embodiments, the filter plate may be a bandpass colored-glass filter, a double-bandpass colored-glass filter, a longpass colored-glass filter, a dielectric bandpass filter, a dielectric shortpass or longpass filter, or any suitable optical filter or combination of suitable optical filters. In particular embodiments, the filtering function of sub-pixel 310 may be combined with the reflective surface 720 by depositing a thin-film dielectric coating that reflects particular wavelength ranges (e.g., red and green) and transmits particular wavelength ranges (e.g., blue).

In FIG. 9A, with a large gap (e.g., several light wavelengths) between surface 710A of the solid interior volume and surface 710B, incident light beam 210A may be reflected at surface 710A through total internal reflection. As front surface 710B of the filter plate is moved closer to surface 710A of the solid interior volume, more light of incident light beam 210B may be transmitted or coupled across the gap via evanescent wave coupling. In particular embodiments, this transmitted light may be optically filtered by the filter plate and reflected from back surface 720. In particular embodiments, the amount of light coupled across the gap between surfaces 710A and 710B may be modulated by changing the spacing profile of the gap. In FIG. 9A, the spacing profile of the gap may be changed by tilting or rotating the filter plate as shown by movement arrow 900A. In particular embodiments, the size of the gap may be changed by moving the filter plate with respect to the solid interior volume. In particular embodiments, the filter plate may be mechanically coupled to an actuator such as a microelectromechanical systems (MEMS) structure or a piezoelectric material. In particular embodiments, the filter plate may be moved by a drive signal or a control voltage that is supplied by display controller 520 and is electrically coupled to an actuator. In FIG. 9B, filter plate may be linearly translated toward and away from surface 710A as shown by movement arrow 900B. In FIG. 9B, incident beams 210A and 210B are totally-internally reflected at surface 710A, and sub-pixel 310 is in a full-on, or maximum reflection, state. As the filter plate is moved closer to surface 710A, more light will be coupled across the gap, and sub-pixel 310 will gradually absorb more light from a particular wavelength range. In FIG. 9C, the filter plate may be made of a flexible or deformable material that can be rolled, squished, or deformed to vary the gap between surfaces 710A and 710B. In particular embodiments, when the filter plate is flat or undeformed, incident beams 210 may couple into the filter, and sub-pixel may be in a full-off, or maximum absorption, state. In FIG. 9C, when the filter plate is rolled or deformed, incident beam 210B may be totally-internally reflected, and sub-pixel may be in a partially-on state. Although this disclosure describes and illustrates a particular retroreflector pixel based on particular evanescent-wave coupling techniques, this disclosure contemplates any suitable retroreflector pixel based on any suitable evanescent-wave coupling technique.

In particular embodiments, other color-modulating techniques or mechanisms may be applied, such as for example electrochromism. In particular embodiments, under an applied voltage, an electrochromic material may reversibly shift between two colors, such as for example between clear (e.g., substantially transparent) and a particular color that absorbs a particular wavelength range of light. Although this disclosure describes and illustrates particular techniques for modulating or filtering color with a sub-pixel of a retroreflector pixel, this disclosure contemplates any suitable technique for modulating or filtering color with a sub-pixel of a retroreflector.

Herein, reference to a computer system may encompass a computing device, and vice versa, where appropriate. Moreover, reference to a computer system may encompass one or more computer systems, where appropriate. This disclosure contemplates any suitable number of computer systems. This disclosure contemplates a computer system taking any suitable physical form. As example and not by way of limitation, a computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a smartphone, a digital camera, a personal digital assistant (PDA), a server, a tablet computer system, or a combination of two or more of these.

Herein, reference to a computer-readable non-transitory storage medium or media may include one or more semiconductor-based or other integrated circuits (ICs) (such, as for example, a field-programmable gate array (FPGA) or an application-specific IC (ASIC)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards, SECURE DIGITAL drives, any other suitable computer-readable non-transitory storage medium or media, or any suitable combination of two or more of these, where appropriate. A computer-readable non-transitory storage medium or media may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. An apparatus comprising:
a retroreflector pixel comprising a plurality of retroreflector sub-pixels, each retroreflector sub-pixel comprising:
a reflective surface configured to reflect incident light; and
a filter element configured to filter out from the incident light an electrically-controllable amount of light over a particular wavelength range.

2. The apparatus of claim 1, wherein:
the retroreflector pixel comprises three retroreflector sub-pixels; and
the reflective surfaces of the three retroreflector sub-pixels are substantially planar and are arranged substantially orthogonal to each other.

3. The apparatus of claim 1, wherein:
the retroreflector pixel comprises a first, second, and third retroreflector sub-pixel;
each reflective element of the first, second, and third sub-pixels is configured to reflect substantially all of the incident light over a first, second, and third wavelength range;
the filter element of the first sub-pixel is configured to filter out from the incident light an electrically-controllable amount light over the first wavelength range;
the filter element of the second sub-pixel is configured to filter out from the incident light an electrically-controllable amount of light over the second wavelength range; and
the filter element of the third sub-pixel is configured to filter out from the incident light an electrically-controllable amount of light over the third wavelength range.

4. The apparatus of claim 3, wherein:
the first wavelength range of light corresponds to a red wavelength range and comprises light within a wavelength range of approximately 570 nm to 700 nm;
the second wavelength range of light corresponds to a green wavelength range and comprises light within a wavelength range of approximately 495 nm to 570 nm; and
the third wavelength range corresponds to a blue wavelength range and comprises light within a wavelength range of approximately 400 nm to 495 nm.

5. The apparatus of claim 1, wherein the amount of light the filter element is configured to filter out from the incident light over the particular wavelength range is electrically controllable from approximately 2% to approximately 80%.

6. The apparatus of claim 1, wherein the reflective surface of each retroreflector sub-pixel is configured to reflect more than approximately 70% of incident light over a visible wavelength range.

7. The apparatus of claim 1, wherein the filter element comprises:
a first liquid that is substantially transparent to the incident light over a visible wavelength range;
a second liquid that absorbs or scatters light over the particular wavelength range; and
an electrode configured to receive an applied voltage, wherein the applied voltage electrically controls an amount of the second liquid in a light path of the filter element.

8. The apparatus of claim 1, wherein the filter element comprises:
a liquid that is substantially transparent to the incident light over a visible wavelength range;
a plurality of charged particles that absorb or scatter light over the particular wavelength range, wherein the charged particles are suspended in the liquid; and
an electrode configured to receive an applied voltage, wherein the applied voltage electrically controls an amount of the charged particles in a light path of the filter element.

9. The apparatus of claim 1, wherein the filter element comprises:
an optical surface of an optical material, wherein the optical material is substantially transparent to the incident light over a visible wavelength range; and
an optical-filter plate that absorbs or scatters light over the particular wavelength range, wherein the optical-filter plate is located adjacent to the optical surface and is configured to move relative to the optical surface.

10. One or more computer-readable non-transitory storage media embodying software that is operable when executed to provide a controller cell for a circuit design, the controller cell being operable to control a plurality of retroreflector sub-pixels, each of the retroreflector sub-pixels comprising:
a reflective surface configured to reflect incident light; and
a filter element configured to filter out from the incident light an electrically-controllable amount of light over a particular wavelength range.

11. The media of claim 10, wherein the controller cell is operable to apply a voltage to an electrode of the retroreflector sub-pixel filter element, wherein the applied voltage electrically controls an amount of a liquid in a light path of the filter element.

12. The media of claim 10, wherein the controller cell is operable to apply a voltage to an electrode of the retroreflector sub-pixel filter element, wherein the applied voltage electrically controls an amount of charged particles in a light path of the filter element.

13. The media of claim 10, wherein the controller cell is operable to apply a drive signal to an actuator coupled to the retroreflector sub-pixel filter element, causing the filter element to move.

14. An apparatus comprising:
a plurality of retroreflector pixels arranged across a surface and configured for use as a display screen, wherein each retroreflector pixel comprises a plurality of retroreflector sub-pixels, each of the retroreflector sub-pixels comprising:
a reflective surface configured to reflect incident light; and
a filter element configured to filter out from the incident light an electrically-controllable amount of light over a particular wavelength range; and
a controller operable to control the filter element of each of the retroreflector sub-pixels.

15. The apparatus of claim 14, wherein:
each of the retroreflector pixels comprises three retroreflector sub-pixels; and
the reflective surfaces of the three retroreflector sub-pixels are substantially planar and are arranged substantially orthogonal to each other.

16. The apparatus of claim 14, wherein:
each of the retroreflector pixels comprises a first, second, and third retroreflector sub-pixel;
each reflective element of the first, second, and third sub-pixels is configured to reflect substantially all of the incident light over a first, second, and third wavelength range;
the filter element of the first sub-pixel is configured to filter out from the incident light an electrically-controllable amount light over the first wavelength range;
the filter element of the second sub-pixel is configured to filter out from the incident light an electrically-controllable amount of light over the second wavelength range; and
the filter element of the third sub-pixel is configured to filter out from the incident light an electrically-controllable amount of light over the third wavelength range.

17. The apparatus of claim 16, wherein:
the first wavelength range of light corresponds to a red wavelength range and comprises light within a wavelength range of approximately 570 nm to 700 nm;
the second wavelength range of light corresponds to a green wavelength range and comprises light within a wavelength range of approximately 495 nm to 570 nm; and
the third wavelength range corresponds to a blue wavelength range and comprises light within a wavelength range of approximately 400 nm to 495 nm.

18. The apparatus of claim 14, wherein the amount of light the filter element is configured to filter out from the incident light over the particular wavelength range is electrically controllable from approximately 2% to approximately 80%.

19. The apparatus of claim 14, wherein the reflective surface of each retroreflector sub-pixel is configured to reflect more than approximately 70% of incident light over a visible wavelength range.

20. The apparatus of claim 14, wherein the filter element comprises:
a first liquid that is substantially transparent to the incident light over a visible wavelength range;
a second liquid that absorbs or scatters light over the particular wavelength range; and
an electrode configured to receive an applied voltage, wherein the applied voltage electrically controls an amount of the second liquid in a light path of the sub-pixel.
